(19) United States
(12) Patent Application Publication
(10) Pub. No.: US 2006/0030512 A1
(43) Pub. Date: Feb. 9, 2006

(54) Cleaner leaving an anti-microbial film

(76) Inventor: Eric R. Hart, Woodburn, KY (US)

Correspondence Address: GREER, BURNS & CRAIN, 300 S WACKER DR, 25TH FLOOR, CHICAGO, IL, 60606, US

(21) Appl. No.: 10/913,559

(22) Filed: Aug. 6, 2004

(51) Int. Cl. C11D 9/00

(52) U.S. Cl. 510/481

(57) ABSTRACT

A surface having a anti-microbial film is disclosed having a dried film on the surface comprising an optically active isomer of a monoester of glycerin and a C₆ to C₂₂ aliphatic acid having antimicrobial activity. A composition for cleaning and inhibiting microbial growth on surfaces includes an emulsion having at least a cationic soap and the monoester. A method for cleaning and inhibiting microbial growth on surfaces is also disclosed that includes providing a mixture of the soap and the optically active isomer of a monoester of glycerin and a C₆ to C₂₂ aliphatic acid having antimicrobial activity, making an aqueous mixture of the mixture and applying the solution on the surface to be cleaned. Preferably the monoester includes at least one of monolaurin, monocaprin and monomyristin.

### FIELD OF THE INVENTION

The invention relates to cleaning products. More specifically, this invention is related to cleaning products that retard regrowth of mildew, molds and fungi on surfaces.

The presence of mold, mildew and fungi in living and working areas has come to public attention as an area for concern. Some parts of buildings, such as carpet backing, cellulose insulation, dry wall or leather furnishings, are extremely difficult to dry if they become wet. Mold spores from the air, or that may have been dormant in the product since its manufacture, will grow and flourish in a moist environment where there is a food source such as cellulose.

Traditional soaps are the metallic salts of the water-soluble reaction products of a fatty acid ester and an alkali metal, with glycerin as a by-product. Typically, commercial cleaning soaps are made by reacting sodium hydroxide with a fatty acid. The alkali metal cation is usually sodium. Soap lowers the surface tension of the water and permits the emulsification of fat-bearing soil particles. These soaps are anionic and are mild antimicrobial agents that are well tolerated by users. However, traditional soaps are effective as prophylactics only for a relatively narrow range of microbes.

Cleaning products that include anti-microbial agents are presently known for cleaning surfaces and for removing mold, mildew and fungi. Many of the antimicrobial agents used are less well tolerated by humans with whom they come in contact. Methanol, for example, is irritating to sensitive skin or broken skin. Others, such as hexachlorophene, are suspected carcinogens. Additionally, the presence of airborne spores reinfects the surface almost immediately after cleaning, leading to regrowth of the contaminants in a short time. Thus, another shortcoming of these products is that they do not prevent or retard regrowth of mold, mildew and fungi on surfaces, even for a limited period of time following cleaning.

Monolaurin, which is the mono glycerol ester of lauric acid, is known as a microbicide. It is a natural ingredient of breast milk, Saw Palmetto, coconut and coconut oil, and therefore is well tolerated by people and animals, including infants. Med-Chem Laboratories, Inc. of Galena, Ill. markets it under the trademark LAURICIDIN. Monolaurin is recognized by the Food and Drug Administration as a food additive and as nutraceutical. The cosmetics industry has also used monolaurin as an additive to eye make-up, such as eyeliners and mascara. It is known as a biocide, killing a wide range of bacteria, molds, mildew, fungi and viruses. However, as with many of the antimicrobial agents listed above, in itself, monolaurin has no lasting effects and does not inhibit regrowth of microbes on the surface recently cleaned. When combined with a traditional soap, the monolaurin is easily wiped, rinsed or worn from the cleaned surface.

### SUMMARY OF THE INVENTION

In accordance with the present invention, a composition and a method for making it are provided which is improved in terms of its ability to inhibit growth of mold, mildew and fungi on surfaces for short periods of time after the surface is treated. The present composition is applied to the surface of any substrate and deposits a film that includes a monoester of a C₆-C₂₂ aliphatic acid on the surface. The result of this coating is that it protects the surface from mold, mildew and fungal growth in harsh environments, such as high humidity, for extended periods of time.

These and other objects are met or exceeded by the present invention of a composition for cleaning a substrate that deposits a film or coating on the substrate surface a monoester of glycerin and a C₆ to C₂₂ aliphatic acid. The preferred vehicle for applying the coating is in the form of an emulsion that includes a cationic soap. When used in cleaning products, the soap cleans the surface of the object being treated and the monolaurin kills microbes present. The composition also deposits a waxy film containing the monolaurin that is not easily rinsed or wiped from the surface. As it is embedded in the film, the monoester remains on the substrate surface to inhibit regrowth of microbes. Other preferred films include either latex or solvent-based paints.

Another benefit of this invention is that the protective film is non-toxic to inhabitants of the living space, including pets and children. One of the preferred monoesters, monolaurin, is a basic ingredient in breast milk for all mammals, and is one component that is believed to contribute to the immunological benefits for infants obtained by nursing. Toys or other surfaces that are cleaned with certain products of this invention are safe for recurring contact with people, even young children who repeatedly put objects in their mouths. The protective film that is deposited on the substrate surface is clean, odorless, hypoallergenic, antiviral, antibacterial and antifungal.

Yet another advantage of this invention is that several versatile cleaners are obtainable that are environmentally friendly. All of the preferred components are biodegradable, producing minimal environmental impact.

The protective coating can also be formulated to match almost any pH suitable for the object being cleaned or the product being formulated. A scum remover of pH 12.5 can be made for cleaning bathrooms. Grease can be removed from car parts or fabric using a cleaner with a pH of about 8.5. Mild acid cleaners can be formulated for use on plants, skin or hair. Stronger acid cleaners having a pH of about 3.5 can be used to remove scum without the possibility of leaving a slippery surface.

Prevention of mold and fungus also protects the surfaces and environment from the by-products that accompany them. Surfaces used for growth of microbes are often damaged or stained by the microbes. Foul odors and spores are released into the air by mold and mildew, resulting in unpleasant smells and the possibility of allergic reactions. In addition to preservation of the goods protected by this invention, the surroundings are healthier and devoid of the odors.

Use of a protective coating such as this by manufacturers would also inhibit moving of molds, viruses and bacteria from one part of the country to another. Environmental science teaches that when an organism is placed into a non-native environment, it can sometimes disrupt that environment. People who have developed immunities to the molds and bacteria in their area may react to different strains of the organisms that come from products manufactured elsewhere. Use of this protective film prior to shipping would kill organisms from the originating location and inhibit growth during transport to the destination.

In one embodiment, the solution is applied to paper, such as the facing on wallboard or drywall, to protect it from mold and mildew damage. Application of the solution to contaminated facings prevents the spread of the mold or mildew to other parts of a home or business. Following application, the facing sheets are ready to receive a decorative coating, such as paint or wallpaper.

A solution of another embodiment is applied to carpet in public areas or private homes. When cleaned with a cleaning solution that includes a monoester, a home carpet stays cleaner and virtually mold-free for a period of months before normal amounts of dirt and mold begin to accumulate.

A solution of still another embodiment can be applied to old leather bound books and antiquities to protect them from mold damage.

### BRIEF DESCRIPTION OF THE DRAWINGS

FIG. 1 shows a photograph depicting the results of drywall testing described in Example 5.

### DETAILED DESCRIPTION OF THE PREFERRED EMBODIMENTS

The instant invention relates to a composition and a method of making it that forms protective coating on a number of surfaces including, but not limited to wood, fabric, carpet, plastic, paper, leather and the like, inhibiting growth of microbes, mold and fungus.

The primary component of the protective coating or film of this invention is a monoester of glycerin and a C₆ to C₂₂ aliphatic acid. A general chemical formula for the monoester is:
CH₂OH—CHOH—CH₂—O—CO—(CH₂)ₓ—CH₃ (I)

where x is from about 4 to about 18. Preferred esters are made from natural acids, particularly capric acid, lauric acid and myristic acid. Although any monoester of the above formula is suitable for use with this invention, monolaurin polyol ester, also known as monolaurin, is the preferred ester and will be discussed in detail herein. Although the discussion is couched in terms of monolaurin, unless otherwise noted, the comments apply to monocaprin, monomyristin and the other monoesters of formula (I) as well. All monoesters disclosed here are believed to have some biological activity, but the monolaurin form is especially effective since it can dissolve certain protein sheaths on bacteria, fungi and viruses.

The ester is formed by reacting glycerin with lauric acid in the presence of an acid or base catalyst. Reactions are most prevalent at the terminal carbons on the glycerin molecule. It is likely that the reaction also takes place at the second carbon atom, but it occurs to a lesser extent, possibly due to steric hindrance. Attachment of the acid to the first and third carbons of the glycerin molecule occur in approximately equal numbers, leading to the formation of optical isomers. A food grade monolaurin and method of making it are disclosed in U.S. Pat. No. 4,002,775, herein incorporated by reference.

One of the enantiomers of monolaurin is believed to be responsible for its biological activity against gram-positive bacteria, fungi and viruses. It is unknown which of the isomers exhibits the biological activity. Without wishing to be bound by theory, it is well known that the right-hand or d form of most enantiomers is most active in biological systems. Thus it is most likely that the d-form of monolaurin is responsible for the antibacterial, antifungal and antiviral properties. However, providing a racemic mixture of both optically active forms assures that the proper form will be present.

As an alternative to making monolaurin, monocaprin or monomyristin, these monoesters occur naturally in coconut palm oil. The monolaurin, or other desired components, are separable from coconut palm oil by well-known techniques. A substantially pure monolaurin is also available for purchase under the trademark LAURICIDIN, marketed by Med-Chem Laboratories, Inc. of Galena, Ill. or Colonial Monolaurin marketed by Colonial Chemical of South Pittsburg, Tenn.

Monolaurin is used in film-forming compositions in amounts that vary depending on the use of the composition. It is useful in amounts of from about 0.1% to about 50% based on the weight of the composition of the soap concentrate (prior to the final addition of water). Preferably, the monolaurin is present in amounts of about 0.25% to about 10% by weight based on the concentrated soap solution. Even more preferably, the monolaurin is used in concentrations of about 0.5% to about 5% by weight of the soap concentrate.

Monolaurin is a highly polar molecule that dissolves readily in polar solvents. It is added, for example, to solvent- or oil-based paints without the need for any additional solvents, dispersants or emulsifiers. However, when used with water-based compositions, a one or more solvents are preferably used to dissolve the monolaurin readily in preparation to forming an emulsion. Alcohols having seven carbon atoms or less are preferred solvents, and alcohols having four carbon atoms or less being more preferred. Higher alcohols may be useful in some compositions but tend to be very waxy. The useful amount of alcohol is at least 20% of the monolaurin by weight, although at the lower end the alcohol may require heating to maintain a supersaturated solution. Even a paste of monolaurin with the solvent may be used if it carries the monolaurin and allows it to disperse in the final composition. Preferably the ratio of alcohol to monolaurin is from about 1:2 to about 2:1. Another preferred solvent is ethylene glycol monobutyl ether, marketed under the trade name Butyl Cellusolve (Dow Chemical Co., Midland, Mich.). Other solvents include d-limonene, alcohols, acetates, ether glycol solvents and the like. D-limonene (Florida Chemical Co. Inc., Winter Haven, Fla.) is useful as an optional solvent and additive in a microemulsion situation. In addition to dissolving the monoester in the microemulsion, it promotes good film integrity when used in amounts of from about 0.5% to about 30% by weight. In sunlight D-limonene forms a film by itself and with the monolaurin film. When used with the present film-forming composition, the D-limonene film reinforces the monolaurin soap film.

Depending on the solvent selected, approximately a 0.2:1 to a 10:1 ratio of solvent to monolaurin based on weight is useful. Ratios of about 0.5:1 to about 3:1, and of about 0.8:1 to about 1.5:1 are preferred. Heating may be needed to fully dissolve the monolaurin and depends on the chosen solvent. When a 1:1 ratio of monolaurin and 91% isopropyl alcohol are combined, the mixture is heated to 120° F. (65° C.) to fully dissolve the monolaurin. As the amount of solvent changes or the nature of the solvent changes, the temperature needed to dissolve the monolaurin is also adjustable.

A cationic soap is preferably used to form the protective film that delivers the monolaurin to the surface to be protected. In cationic soaps, the surface-active portion of the molecule is the cation. Any cationic soap is useful in this invention as a vehicle for delivering a monoester film. Examples of commercially available soaps include heavy-duty detergent concentrates and liquid soaps that include quaternary soaps such as a quaternized heptadecyl imidazole (COLAQUAT IES, Colonial Chemical, Inc., South Pittsburg, Tenn.), amine soaps including C₆-C₂₂ alkyl amine oxides, diethanolamines such as Colaterge APDC, cocamido propyl phosphotidal PG dimonium chloride, such as Colalipid C, alkanolamides, such as Colamine 11CM (all available from Colonial Chemical, Inc., South Pittsburg, Tenn.). Amine based cationic soaps are gentle for use in baby products or products for sensitive skin. Those skilled in the art of formulating such compositions will recognize that other cationic soaps are useful. Any amount of cationic soap is useful that is effective to form a film in combination with the monolaurin. Prefreably, a soap concentrate includes about 0.05% to about 5% by weight of one or more cationic soaps, more preferably about 0.1% to about 1% by weight.

At least one cationic soap is present to give the cationic nature to the protective film so that it is deposited with the monolaurin. Combinations of cationic soaps are also very useful, depending on the type of composition that is being formulated. The addition of an amphoteric soap in addition to the cationic soap provides good cleaning ability in a wide range of pH in the make-up water. Preferred amphoteric soaps include, but are not limited to amphoteric sodium dicarboxyethyl coco phosphoethyl imidizole, marketed as Colateric AP, capryloamphopropionate, such as Colateric 2COSF (both of Colonial Chemical, Inc., South Pittsburg, Tenn.). When Conventional anionic soaps are combinable with the cationic soap where a stronger detergent formula is desired. Preferred detergents are amido sulfonate complexes, such as Coladet SDC and Coladet 100, marketed by Colonial Chemical of South Pittsburg, Tenn.

When used in an aqueous system, the monolaurin and solvent are preferably emulsified to increase solubility in water. Formation of a clear microemulsion is particularly preferred. A preferred emulsifier is Colamuse SBC (Colonial Chemical, South Pittsburg, Tenn.) that readily forms a clear microemulsion similar to those found in clear dishwashing liquids. Any amount of Colamuse SBC is useful in this product that forms a clear microemulsion. The emulsifier is preferably used in amounts of from about 10% to about 30% by weight of the composition. Other suitable emulsifiers include, but are not limited to Triton X-405 or 100, a nonionic surfactant, and others that are anionic, nonionic or cationic types.

The soap emulsion also allows for the addition of surfactants to provide specific properties for specific applications. Soap emulsions are adaptable to accommodate a high degree of heavy or light oils. Quaternary ammonium compounds, such as quaternized heptapentyl imidazoles such as Colaquat IES (Colonial Chemical, South Pittsburg, Tenn.) are effective surfactants and are available in a wide variety of forms to suit many applications.

The delivery system is adjustable to form a film from compositions over a pH range of 0.5 to 14 by changes to the composition. This allows the preparation of products in virtually any pH range desired. In the basic range, the film forms easily in the range of about 7 to about 10, with 8.5 being optimum. At higher pH, the monolaurin emulsifies so that it does not form a film. This is believed to be due to neutralization of the cations of the soap/monolaurin system by the basic environment. However, the optional addition of zwitterionic or proteinaceous materials, such as animal collagen (Tri-K Corp., Northvale, N.J.) stabilizes the monolaurin. Any base, such as caustic soda, is then used to adjust the pH to the desired level. At a pH of 7 or less, lanolin or collagen are useful in stabilizing the monolaurin, and an acid, such as glycolic acid or urea hydrochloride, is used to adjust the pH to the desired value.

The protective film can be used in a persistent or a non-persistent manner. When used as a cleaning agent, the monolaurin and cationic soap form a film as the water and solvent evaporate from the substrate surface. The film has a waxy nature from the soap, and so it adheres to the surface. Additionally, if the surface is negatively charged, as with carpeting or glass, the cationic soap is held to the surface by the ionic attraction. When applied on a smooth surface, such as a porcelain fixture or a counter top, it imparts a waxy shine to the surface. This waxy film holds the monolaurin in place on the surface, providing long-lasting antimicrobial protection to the substrate as long as the film is in place. Soaps and concentrates of this invention are water-soluble and therefore would be dissolved and rinsed away if placed in contact with water. The film can be made permanent if the surface is treated with a water-proof sealant, such as silicone fluids, petroleum petrolatums or the like.

Optionally, the monolaurin is saponified with a chelating agent to form a more effective, more durable and longer lasting anti-microbial agent. With the help of chelating agents, such as ethylenediamine tetraacetic acid, (“EDTA”) or ethylenediamine disuccinic acid (“EDDS”), the efficacy of monolaurin is extended to gram negative bacteria as well as gram positive bacteria. When separated from the monoester, these chelating agents sequester minerals from the mold or bacteria so that they are unable to synthesize the necessary enzymes necessary for their biological systems. For example, when equal parts of monolaurin and EDTA are dissolved in alcohol and heated to 110° F. to 120° F., they are converted to a monolaurin-EDTA complex. As long as the chelating agent and the mono laurin are complexed by the glycerin molecule, the both the monoester and the chelating agent loose their microbiocidal activity. The saponified monolaurin is delivered to the area to be protected where it optionally remains dormant for weeks or months. Upon a sudden change in pH, such as organisms secreting enzymes, the monolaurin and the chelating agent separate and become active again. The presence of calcium, zinc or magnesium ions or any other chemical agent that would cause a sudden pH change could trigger the separation of the saponified monolaurin. Thus, the complex remains in the film until it is attacked by a mold, for example, then changes in pH release the chelating agent and the monolaurin to act upon the mold, destroying it.

When chealting agents are present, additional adjustments to the composition may be needed in certain pH ranges. EDTA and EDDS precipitate out at a pH less than 7. The addition of thickeners such as ethyl cellulose or methyl cellulose are optionally added to form a suspension. Proteins or collagen added to the composition provide an alternate way of solubilizing the chelating agents. These compounds are preferably added in amounts ranging from about 0.2% to about 40%.

Those skilled in the art will also recognize other additives useful in preparing soaps, films and coatings for a particular application. Colorants and dyes are optionally added to the coating for aesthetic purposes. UV absorbers, heat stabilizers, anti-oxidants and anti-ozodants are optionally added to the composition of this invention. Other optional additions include extending polymers and waxes, corrosion inhibitors such as Colacor RP or Colacor C1-24 (Colonial Chemical, Inc., South Pittsburg, Tenn.), sequestering agents, water repellants, quaternary biocides, acids and bases to set pH.

The monolaurin-containing film is optionally applied to virtually any surface to protect it from attack by microbes. Examples of surfaces include, but are not limited to drywall, paper, cardboard, carpet, plastic, fibers, glass, wood, laminate, metals, ceramic, porcelain, fabric and any other suitable surface. It is not limited to use on inanimate objects, and could be sprayed on plants to form a persistant film to provide long-term antimicrobial protection to crops. Medicinal products, such as salves, can be formulated to reduce infection in burns. The film is preferably applied by brushing, rolling, screeding, spraying, wiping or spreading.

In the following examples, monolaurin is used in a variety of films on surfaces for its anti-microbial properties.

### EXAMPLE 1

This embodiment produces a basic, mild soap solution suitable for cleaning wood, applicances, kitchen counters and the like. Components used to make the emulsion are listed in Table I.

TABLE I

| Component | Name | % by Weight |
|---|---|---|
| Solvent | 91% Isopropyl Alcohol | 3.8% |
| Antimicrobial agent | Monolaurin | 3.8% |
| Detergent | Coladet SDC | 89.8% |
| Cationic Soap | Colaquat IES | 0.4% |
| Amphoteric soap | Colateric AP | 2.4% |

Equal parts of 91% Isopropyl Alcohol and monolaurin were mixed together at 110° F. to about 120° F., until dissolved. This solution is then added to the soap solution comprising the remaining three components to make a soap concentrate. When the mixture is blended, it is let down in water at a ratio of 8:1 to make a working soap solution.

This soap was used to clean wood cabinets and kitchen appliances. The cleaning was excellent and the protective film was observable. The mild cleaner did not harm the finish of the wood cabinets.

### EXAMPLE 2

A strong soap was formulated in a microemulsion. This soap is useful for degreasing, cleaning carpet, protecting dry wall panels or draperies. The concentrate is also used as a base for specialized formulas. Ingredients to make this soap are included in Table II.

TABLE II

| | | Amount, |
|---|---|---|
| | | Parts by |
| Component | Name | Weight |
| 1. Solvent | D-limonene | 100 |
| 2. Emulsifier | Colamuse SBC | 100 |
| 3. Amphoteric Soap | Colateric AP | 6.5 |
| 4. Corrosion Inhibitor | Colacor RP | 1 |
| 5. Corrosion Inhibitor | Colacor C1-24 | 1 |
| 6. Cationic Soap | Colaquat IES | 1 |
| 7. Quaternary Soap | Colalipid C | 5 |
| 8. Surfactant | Sugaquat S-1210 | 5 |
| 9. EDTA | Versene 100 | 2 |
| 10. Solvent | Isopropyl Alcohol, 91% | 10.25 |
| 11. Antimicrobial Agent | Monoester of lauric acid | 10.25 |
| 12. amido sulfonate detergent | Coladet SDC | 145.2 |
| complexes | | |
| 13. Surfactant | Colamine 11 CM | 48.4 |
| 14. Solvent | Isopropyl alcohol, 91% | 106.48 |

The first two components, D-limonene and Colamuse SBC, were mixed together gently to form a microemulsion. In a separate vessel, the chelating agent, EDTA was adjusted to a pH of 8.5 with citric acid. The next seven components, the soaps, surfactants, chelating agent, corrosion inhibitors, monolaurin and isopropyl alcohol, were added to the d-limonene mixture and mixed together. A crystal clear microemulsion resulted. This composition was referred to as “Formula A.”

Next, the remaining components 12-14, the Colamine, Coladet and alcohol, were added to 242 parts of Formula A and blended well. The additional alcohol increased the stability of the system so that the soaps did not separate. This composition is referred to as the “Formula #2 Concentrate.”

Finally, to make a working soap, the system was let down with water, using approximately 16 parts water per part of mixture by weight. This soap composition is referred as “Formula #2 Soap”.

In November of 2003, an area of a professionally cleaned carpet was treated with Formula #2 Soap. Within ten minutes, stains that had not been removed by the professional cleaning disappeared, leaving the carpet clean and soft. Eight months after the treatment, the untreated portion of the carpet had become dirty, was professionally cleaned and has become dirty again, while the treated area remained clean and bright. The negatively charged carpet fibers appear to be particularly receptive to the cationic film and hold it tightly in place.

### EXAMPLE 3

TABLE 3
Acid Cleaner Concentrate

| Component | Name | Amount, Wt % |
|---|---|---|
| pH Adjuster | Urea Hydrochloride | A.S. to desired pH |
| Acid Stabilizer | Collagen | 5-40% |
| Chelating Agent | EDDS | 0.1-8% |
| Monolaurin Soap | Formula #2 Concentrate | 40-95% |
| PH Adjuster | Glycolic Acid (pH | 0.25-10% |
| | adjusted to 5.5) | |
| Thickener | Carbopel EZ-2 | 0-2% |
| Thickener | Ethanolamine | 0-0.25% |

The above example is a cleaner for surfaces that require a gentle acid cleaner.

### EXAMPLE4

A thickened Formula #2 Concentrate was formulated by adding about 1% by weight of Carbopol (Flour Corp., Aliso Viejo, Calif.) and a few drops of ethanolamine to make a pourable gel.

Two ounces of a lanolin emulsion (Lanexol AWS, Croda Corp., Edison, N.J.) and 1 ounce of APS 328 Silicone Gel (Advanced Polymer Systems, Redwood City, Calif.) were combined with 29 ounces by weight of the thickened Formula #2 Concentrate. After mixing, this concentrate was let down with water at a ratio of about 16 parts water to 1 part concentrate by volume. This product is referred to as the “Leather Formula.”

A saddle that was substantially covered with mold was cleaned using the Leather Formula. The leather did not darken or discolor in any way. After cleaning, the leather was soft and supple, and appeared like new. No dirt or mold has accumulated on the saddle as it appeared in the two months since it was cleaned.

### EXAMPLE 5

Two gypsum panels were cut to the same size. One panel was sprayed on both sides with Formula #2 Soap until the surface was saturated with liquid. Both panels were immersed in a tank containing 2-3 inches of water contaminated with mold and fungus. After drying, both the panels were inoculated with a mold, Aspergillus Niger. The panels were placed about 12 inches above the water pan, loosely covered with black plastic and placed in a room at 80° F.

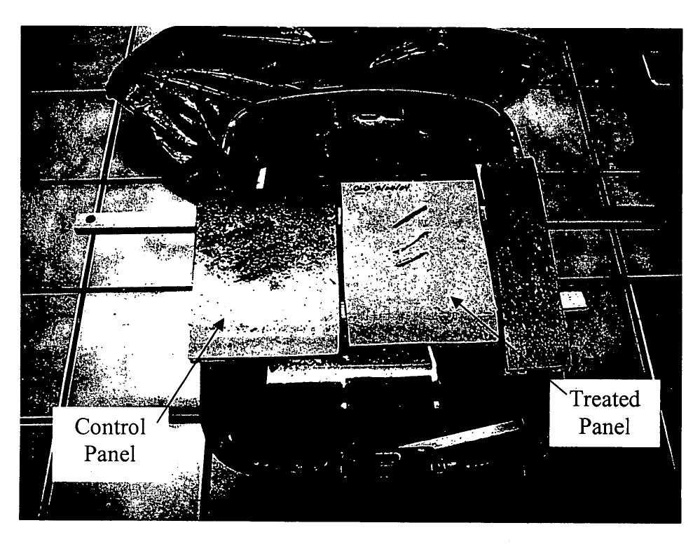

The results of the test are shown in FIG. 1. After 60 days, the treated panel showed no mold growth upon a visual inspection, while the black mold growth is apparent on the control panel.

While there have been illustrated and described particular embodiments of the present invention, it will be appreciated that numerous changes and modifications will occur to those skilled in the art. Soaps or cleaners using monolaurin and cationic soaps can be made to treat most any surface using the knowledge and skill of a formulator of such compositions. It is intended in the appended claims to cover all those changes and modifications which fall within the true spirit and scope of the present invention.

What is claimed is:

1. A concentrated cleaning composition for inhibiting regrowth of microbes on surfaces comprising:
an emulsion comprising
a cationic soap; and
a monoester of glycerin and a C₆ to C₂₂ aliphatic acid.

2. The composition of claim 1 wherein said monoester comprises at least one of monocaprin, monolaurin and monomyristin.

3. The composition of claim 2 wherein said monoester comprises monolaurin.

4. The composition of claim 1 further comprising an amphoteric soap.

5. The composition of claim 1 further comprising a chelating agent.

6. The composition of claim 5 wherein said chelating agent is at least one of ethylenediaminetetraacetic acid and ethylenediamine disuccinnic acid.

7. The composition of claim 1 further comprising a solvent for the monoester.

8. The composition of claim 1 wherein said emulsion is a microemulsion.

9. A method for cleaning and inhibiting microbial growth on surfaces comprising:
providing an emulsion of a cationic soap and a monoester of glycerin and a C₆ to C₂₂ aliphatic acid;
adding water to the emulsion form an aqueous solution; and
applying the solution to the surface to be cleaned.

10. The method of claim 9 wherein said providing step further comprises dissolving the monoester in a solvent and adding at least one of a surfactant and a soap.

11. The method of claim 10 wherein said providing step further comprises saponifying the monoester with a chelating agent.

12. The method of claim 9 wherein said applying step comprises brushing, screeding, spraying, rolling, wiping or spreading.

13. The method of claim 9 further comprising emulsifying the mixture.

14. A surface having a non-persistent anti-microbial film comprising:
a surface; and
a dried film on said surface comprising a monoester of glycerin and a C₆ to C₂₂ aliphatic acid and a cationic soap.

15. The surface of claim 14 wherein said monoester comprises at least one of monocaprin, monolaurin and monomyristin.

16. The surface of claim 14 wherein said film further comprises an amphoteric soap.

17. The surface of claim 14 wherein said film further comprises a soap.

18. The surface of claim 14 wherein said surface is an inanimate surface.

19. The surface of claim 18 wherein said surface comprises at least one of wood, plastic, paper, leather, glass, drywall, ceramic and metal.

20. The surface of claim 19 wherein said surface comprises drywall.

21. The surface of claim 14 wherein the monoester in said film is saponified with at least one of ethylenediamine tetraacetic acid and ethylenediamine disuccinate.
